(19) United States
(12) Patent Application Publication
(10) Pub. No.: US 2025/0086014 A1
(43) Pub. Date: Mar. 13, 2025

(54) MEMORY MANAGEMENT METHOD AND APPARATUS CONSIDERING PERFORMANCE INFORMATION

(71) Applicant: Samsung Electronics Co., Ltd., Suwon-si (KR)

(72) Inventors: Changhyeon CHAE, Suwon-si (KR); Kyeonghwan JUNG, Suwon-si (KR); Jihun JUNG, Suwon-si (KR); Jaeook KWON, Suwon-si (KR); Jusun SONG, Suwon-si (KR); Jaehoon JEONG, Suwon-si (KR); Youngho CHOI, Suwon-si (KR)

(21) Appl. No.: 18/960,949

(22) Filed: Nov. 26, 2024

Related U.S. Application Data
(63) Continuation of application No. PCT/KR2023/008050, filed on Jun. 12, 2023.

(30) Foreign Application Priority Data
Jul. 26, 2022 (KR) 10-2022-0092286

(51) Int. Cl. G06F 9/50; G06F 11/34

(52) U.S. Cl. CPC G06F 9/5016; G06F 11/3442

(57) ABSTRACT

Various embodiments of the present disclosure relate to a memory management method and apparatus which perform a memory return operation by dynamically setting a memory threshold value by additionally considering performance information of an electronic apparatus in addition to an amount of available memory. An electronic apparatus comprises: a memory that stores at least one instruction corresponding to at least one program; and at least one processor, comprising processing circuitry, electrically connected to the memory, wherein at least one processor, individually and/or collectively, is configured to execute the at least one instruction as a process, and to: acquire performance information of the electronic apparatus and an amount of available memory; determine a memory threshold value based on the performance information and the amount of available memory; update a memory threshold value to the determined memory threshold value; and based on the amount of available memory being less than the memory threshold value at a certain point in time, terminate a certain process.

### CROSS-REFERENCE TO RELATED APPLICATIONS

This application is a continuation of International Application No. PCT/KR2023/008050 designating the United States, filed on Jun. 12, 2023, in the Korean Intellectual Property Receiving Office and claiming priority to Korean Patent Application No. 10-2022-0092286, filed on Jul. 26, 2022, in the Korean Intellectual Property Office, the disclosures of each of which are incorporated by reference herein in their entireties.

### BACKGROUND

### Field

The disclosure relates to a memory management method and device that perform a memory return operation by dynamically setting a memory threshold by additionally considering performance information about an electronic device in addition to an available memory amount.

### Description of Related Art

An electronic device may be unable to recover in the worst case scenario if the minimum memory required for operation is not maintained and may thus monitor available memory when memory allocation is required or periodically and, if determined to be necessary, perform a memory return operation on memory in use. The electronic device may perform memory return operation on memories used by, e.g., the kernel and application/service programs resident in memory as part of the operating system (OS).

The memory return operation may be performed through memory reallocation (reclaim) or process termination (kill). The memory return operation through memory reallocation may return memory by selecting a memory to be returned while keeping the process running and moving (swap-out) the content of the selected memory to a swap medium (or device) or dropping it (e.g., release of linking to the allocated memory area). In the memory return operation through process termination, when the available memory in the system is insufficient (e.g., when it is less than a predetermined threshold), the memory in use due to the execution of the corresponding process may be returned by forcedly terminating the process determined to be of low importance by a predetermined priority among the processes being executed.

When the electronic device determines whether the available memory is insufficient based on the memory threshold preset as a fixed value and terminates a process, it is impossible to optimize and reflect, e.g., the user's device usage pattern in memory management. Further, when the available memory is the predetermined threshold or more, the memory return operation by process terminal is not performed but, as the available memory includes memory returnable through memory reallocation, the memory return operation through memory reallocation may be performed. In this case, device overhead such as of CPU or swap medium may occur in selection of reallocation memory, swap-out/in or file drop/loading task, and it may affect the performance of the running application, resulting in deterioration of usability of the electronic device.

### SUMMARY

Embodiments of the disclosure provide a memory management method and device that perform a memory return operation by dynamically setting a memory threshold by additionally considering performance factors (or performance information) of an electronic device in addition to an available memory amount.

According to an example embodiment of the disclosure, an electronic device may comprise: a memory storing at least one instruction corresponding to at least one program, and at least one processor, comprising processing circuitry, electrically connected to the memory, wherein at least one processor, individually and/or collectively configured to execute the at least one instruction as a process and to: obtain performance information about the electronic device and an available memory amount, determine a memory threshold based on the performance information and the available memory amount, update the memory threshold with the determined memory threshold, and based on the available memory amount at a specified time being less than the memory threshold, terminate a specified process.

According to an example embodiment, the performance information may include at least one of a CPU usage overhead of a memory reallocation process, a memory swap-out/in overhead due to memory reallocation, a file drop/loading overhead due to memory reallocation, and an application response speed.

According to an example embodiment, at least one processor, individually and/or collectively, may be configured to: obtain the performance information and available memory amount, determine the memory threshold, and update the memory threshold at a specified period.

According to an example embodiment, at least one processor, individually and/or collectively, may be configured to set at least one of a maximum memory threshold and a minimum memory threshold based on an external input.

According to an example embodiment, at least one processor, individually and/or collectively, may be configured to: determine whether the available memory amount exceeds the memory threshold and whether a performance of the electronic device is less than a specified performance criterion based on the performance information, and based on the performance of the electronic device being less than the specified performance criterion although the available memory amount exceeds the memory threshold, increase the memory threshold by a specified increment.

According to an example embodiment, at least one processor, individually and/or collectively, may be configured to: determine whether the available memory amount exceeds the maximum memory threshold and whether a performance of the electronic device is a specified performance criterion or more based on the performance information, and based on the performance of the electronic device being the specified performance criterion or more, and the available memory amount exceeds the maximum memory threshold, decrease the memory threshold by a specified decrement.

According to an example embodiment, at least one processor, individually and/or collectively, may be configured to increase the memory threshold by the specified increment within a limit of the maximum memory threshold.

According to an example embodiment, at least one processor, individually and/or collectively, may be configured to decrease the memory threshold by the specified decrement within a limit of the minimum memory threshold.

According to an example embodiment of the disclosure, a memory management method may comprise: obtaining performance information about an electronic device and an available memory amount, determining a memory threshold based on the performance information and the available memory amount, updating the memory threshold with the determined memory threshold, and based on the available memory amount at a specified time being less than the memory threshold, terminating a specified process.

According to an example embodiment, the performance information may include at least one of a CPU usage overhead of a memory reallocation process, a memory swap-out/in overhead due to memory reallocation, a file drop/loading overhead due to memory reallocation, and an application response speed.

According to an example embodiment, obtaining the performance information and the available memory amount, determining the memory threshold, and updating the memory threshold may be performed at a specified period.

According to an example embodiment, the method may further comprise setting at least one of a maximum memory threshold and a minimum memory threshold based on an external input.

According to an example embodiment, determining the memory threshold may include: determining whether the available memory amount exceeds the memory threshold and whether a performance of the electronic device is less than a specified performance criterion based on the performance information, and based on the performance of the electronic device being less than the specified performance criterion although the available memory amount exceeds the memory threshold, increasing the memory threshold by a specified increment.

According to an example embodiment, determining the memory threshold may include: determining whether the available memory amount exceeds the maximum memory threshold and whether a performance of the electronic device is a specified performance criterion or more based on the performance information, and based on the performance of the electronic device being the specified performance criterion or more, and the available memory amount exceeding the maximum memory threshold, decreasing the memory threshold by a specified decrement.

According to an example embodiment, increasing the memory threshold by the specified increment may increase the memory threshold by the specified increment within a limit of the maximum memory threshold.

According to an example embodiment, decreasing the memory threshold by the specified decrement may decrease the memory threshold by the specified decrement within a limit of the minimum memory threshold.

According to an example embodiment of the disclosure, there may be included a non-transitory computer-readable recording medium recording a program for performing the method.

According to various example embodiments of the disclosure, a memory return operation may be performed by dynamically setting a memory threshold by further considering performance information about an electronic device in addition to the available memory amount. Accordingly, it is possible to mitigate deterioration of performance of the device that may occur as a memory return operation through memory reallocation is performed in a circumstance where the available memory amount is larger than the memory threshold. In other words, it is possible to enhance memory recovery and device performance by advancing the execution of the memory return operation through process termination by dynamically setting a memory threshold in a circumstance where device performance is deteriorated without memory recovery only with the memory return operation through memory reallocation.

Further, since the user's device use pattern may be optimized and reflected in memory management by considering the device performance information in dynamically setting a memory threshold, it is possible to enhance the user's device usability and satisfaction. For example, as the memory threshold is dynamically increased when the user frequently uses a heavy application requiring high device resource demand such as memory, the background application may be more quickly terminated, allowing the running foreground application to smoothly use device resources. On the other hand, as the memory threshold is dynamically decreased when the user often uses a light application, relatively more applications previously executed may remain in the background without being terminated and, as necessary, quickly switch to foreground application, enhancing the user's device usability and satisfaction.

Effects achievable by example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an electronic device according to various embodiments;

FIG. 2 is a flowchart illustrating an example memory return method through process termination according to various embodiments;

FIG. 3 is a flowchart illustrating an example method of dynamically updating a memory threshold based on an amount of available memory and performance information about a device according to various embodiments; and

FIG. 4 is a diagram illustrating example memory swap-out/in overhead due to memory reallocation among device performance information according to various embodiments.

### DETAILED DESCRIPTION

Hereinafter, various example embodiments of the disclosure are described in greater detail with reference to the drawings. However, the disclosure may be implemented in other various forms and is not limited to the example embodiments set forth herein. The same or similar reference denotations may be used to refer to the same or similar elements throughout the disclosure and the drawings. Further, for clarity and brevity, no description may be made of well-known functions and configurations in the drawings and relevant descriptions.

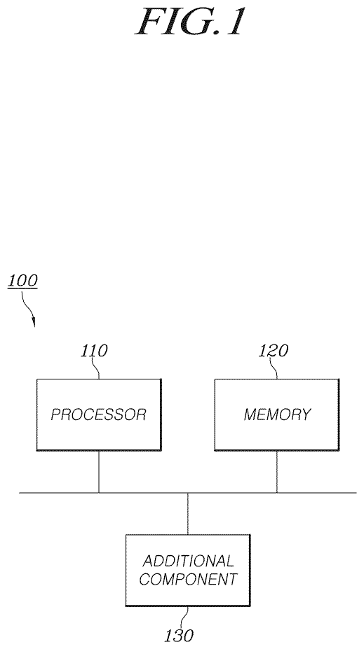

FIG. 1 is a block diagram illustrating an example configuration of an electronic device according to various embodiments.

According to an embodiment, the electronic device 100 may include, but is not limited to, one or more processors (e.g., including processing circuitry) 110 and one or more memories 120. The electronic device 100 may include an additional component (e.g., including various circuitry and/or executable program instructions) 130. The electronic device 100 may include additional components other than the illustrated components, or may omit at least one of the illustrated components.

According to an embodiment, the one or more processors 110 may include a storage and processing circuit unit for supporting the operation of the electronic device 100. The storage and processing circuit unit may include storage, such as non-volatile memory (e.g., flash memory, or other electrically programmable ROM configured to form a solid state drive (SSD)) or volatile memory (e.g., static or dynamic RAM). The processing circuit unit in the processor 110 may be used to control the operation of the electronic device 100. The processing circuit unit may be based on at least one of a central processing unit (CPU), a graphic processing unit (GPU), a micro controller unit (MCU), a sensor hub, a supplementary processor, a communication processor, an application processor, an application specific integrated circuit (ASIC), or field programmable gate arrays (FPGA) and may include at least one core. The processor(s) 110 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 120 and additional component 130 described below may be included in an embodiment of the processor and may be provided as functional elements performing specific functions or operations as at least part of the processor or as separate hardware components as entities performing independent functions or operations.

According to an embodiment, the one or more memories 120 may include a storage medium used by the electronic device 100 and may store at least one instruction or data corresponding to at least one program. The data may include configuration information and/or variables used in the protocol, configuration, control and other functions of the electronic device 100, including operations correspond to, or including, any one of methods and/or procedures described in the disclosure by way of non-limiting example. The program may include an operating system (OS) program and various application programs. The memory 120 may include non-volatile memory, volatile memory, or a combination thereof. The memory 120 may interface with a memory slot that enables insertion and removal of removable memory cards in one or more formats (e.g., SD card, Memory stick, compact flash, etc.). The memory 120 may provide the stored data according to a request of the processor 110.

According to an embodiment, the electronic device 100 may include an additional component 130. According to an embodiment, various additional components 130 may be configured depending on the type of the electronic device 100. For example, the additional component may include, but is not limited to, at least one of a transceiver, a display, a power unit (e.g., a battery), an input/output (I/O) unit, a driver, and a computing unit.

According to an embodiment, the electronic device 100 may include a bus. According to an embodiment, one or more system components (e.g., the processor 110, the memory 120, or the like) may be interconnected by one or more buses. In an embodiment, the one or more buses may include a circuit unit that interconnects or controls various combinations of system components in a wired or wireless manner. It will be understood by those skilled in the art that one or more system components may be interconnected by one or more buses, but are not limited thereto and may be interconnected or controlled in various ways.

According to an embodiment, the electronic device 100 may be implemented in the form of, for example, and without limitation, a TV, an extended reality (XR) device, a hologram device, an AI server, a home appliance, a mobile device, a digital broadcasting terminal device, an IoT device, a desktop computer, a laptop computer, a robot, a vehicle, a public safety device, a machine type communication (MTC) device, a medical device, a fintech device, a security device, a climate/environmental device, a base station, a network node, or the like, but is not limited thereto.

According to an embodiment, the processor 110 may determine whether the available memory amount is less than a predetermined memory threshold at a predetermined time, and when the available memory amount is less than the memory threshold, the processor 110 may perform a memory return operation through process termination. In the memory return operation through process termination, when the available memory in the system is insufficient (e.g., when it is less than the memory threshold), the memory in use due to the execution of the corresponding process may be returned by terminating the process determined to be of low importance by a predetermined priority among the processes being executed. The predetermined time may include at least one of a time when memory allocation is required by an application or the like and a predetermined periodic time, but is not limited thereto.

According to an embodiment, the memory threshold may be set, with the value set based on an external input (e.g., a user input) when the device boots up, as the initial value. The processor 110 may dynamically update the memory threshold by additionally considering the available memory amount and the performance information about the electronic device 100. To that end, the processor 110 may obtain the performance information and the available memory amount of the electronic device 100.

The performance information may include, but is not limited to, at least one of the performance overhead caused by the memory return operation through memory reallocation and the application response speed. The performance overhead caused by the memory return operation through memory reallocation may include at least one of CPU usage overhead of the memory reallocation process, memory swap-out/in overhead due to memory reallocation, or file drop/loading overhead due to memory reallocation. The performance information may include various information capable of objectively determining the performance of the electronic device 100.

For example, the CPU usage overhead of the memory reallocation process may include at least one piece of information among the CPU usage and CPU usage percentage by the system program (e.g., Kswapd) performing memory reallocation. The memory swap-out/in overhead due to memory reallocation may include at least one of the time taken to move the memory being used to the swap medium (swap-out) and load the memory back to the memory (swap-in) and the number of times of swap-out/in. The file drop/loading overhead due to memory reallocation may include at least one of the time taken to release (drop) the connection of the OS to the memory in use and load the OS back into the memory in the future and the number of times of drop/loading. The application response speed may include at least one piece of information among the UI response speed from the user and the processing speed for handling the UI from the user. For example, the application response speed may include the response speed such as of the cursor displayed when the user operates the UI of the application using the remote controller, or may include the processing speed for handling the remote controller key, but is not limited thereto.

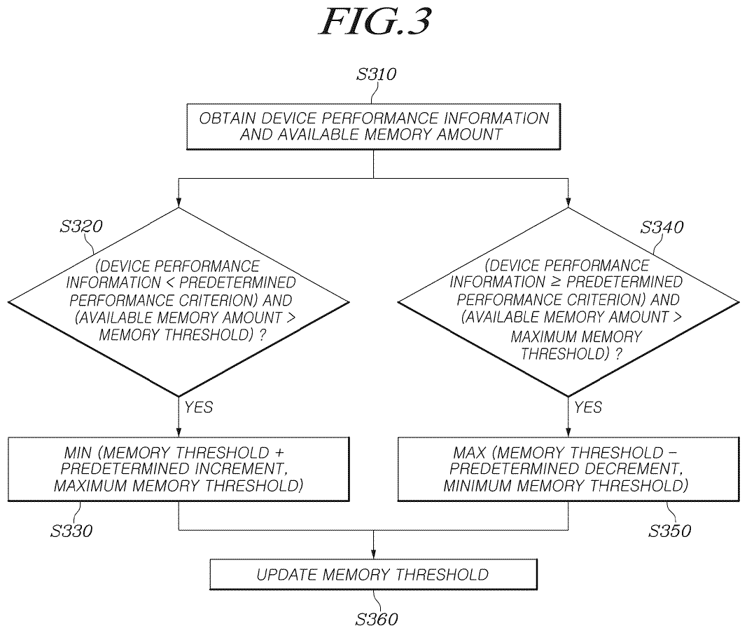

According to an embodiment, the processor 110 may determine a memory threshold based on the performance information and the available memory amount, and update the memory threshold with the determined memory threshold. A more detailed description of dynamic setting of a memory threshold is described below with reference to FIG. 3.

According to an embodiment, although not limited thereto, the processor 110 may obtain the performance information and the available memory amount at a predetermined period, determine a memory threshold, and update the memory threshold.

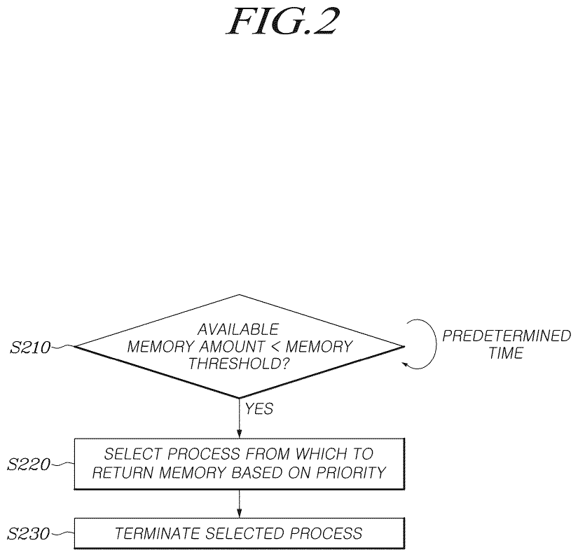

FIG. 2 is a flowchart illustrating an example memory return method through process termination according to various embodiments.

Referring to FIG. 2, in operation S210 according to an embodiment, the electronic device 100 may determine whether the available memory amount is less than a memory threshold at a predetermined (e.g., specified) time. When it is determined that the available memory amount exceeds the memory threshold, operation S210 may be performed again at another predetermined time, and when the available memory amount is less than the memory threshold, operation S220 may be performed. The predetermined time may include at least one time when memory allocation is required by an application or the like and a predetermined periodic time. The memory threshold may be preset with a value set based on an external input (e.g., a user input) used as the initial value. Further, the memory threshold may be dynamically updated based on the available memory amount and the performance information about the electronic device 100. The dynamic update of the memory threshold is described in greater detail below with reference to FIG. 3.

In operation S220, the electronic device 100 may select a process from which to return the memory being used, based on a predetermined priority.

It will be understood by one of ordinary skill in the art that the predetermined priority may be set based on an external input, but may be set in various ways. For example, the predetermined priority may be set in an order of a background application, a favorite application, a service application without restart, a foreground application, a daemon process without restart, a service application with restart, a daemon process with restart, and a VIP process. The background application may refer to an application that has been previously executed but is not currently displayed and is inactive. The favorite application may refer to an application separately assigned a higher priority among background applications. The service application without restart may refer to an application without a restart option among service applications without a user interface (UI). The foreground application may refer to an application currently output on the display and being executed. The daemon process without restart may refer to a daemon process without a restart option among daemon processes operating in the background to respond to a service request. The VIP process may be preset as a VIP process based on an external input, but is not limited thereto.

In operation S230, the electronic device 100 may terminate the process selected in operation S220, thereby returning the memory being used by the selected process.

FIG. 3 is a flowchart illustrating an example method of dynamically updating a memory threshold based on an amount of available memory and performance information about a device according to various embodiments.

According to an embodiment, the electronic device 100 may perform operations S310 to S360 at a predetermined period, but is not limited thereto.

Referring to FIG. 3, in operation S310 according to an embodiment, the electronic device 100 may obtain performance information and an available memory amount. The performance information may include, but is not limited to, at least one of a CPU usage overhead of a memory reallocation process, a memory swap-out/in overhead due to memory reallocation, a file drop/loading overhead due to memory reallocation, and an application response speed. The performance information may include various information capable of objectively determining the performance of the electronic device 100.

In operation S320, the electronic device 100 may determine whether the performance of the electronic device 100 is less than a predetermined performance criterion (e.g., whether the performance criterion is not met), based on whether the available memory amount exceeds a previously set memory threshold and the performance information. When the performance of the electronic device is less than the predetermined performance criterion even when the available memory amount exceeds the previously set memory threshold, the electronic device may move to operation S330.

The predetermined performance criterion may be identified as at least one combination of the performance information. For example, in determining whether it is less than the predetermined performance criterion, the predetermined performance criterion may include at least one of the CPU usage overhead of the memory reallocation process being larger than or equal to a first increase ratio (e.g., 10%) relative to the previous determination period, the swap-out/in overhead due to memory reallocation being larger than or equal to a second increase ratio (e.g., 20%) relative to the previous determination period, the file drop/loading overhead due to memory reallocation being larger than or equal to a third increase ratio (e.g., 20%) relative to the previous determination period, and the application response speed being a predetermined time (e.g., 2 seconds) or more.

In operation S330, the electronic device 100 may increase the memory threshold by a predetermined increment. In this case, the electronic device 100 may increase the memory threshold by the predetermined increment within a limit of the maximum memory threshold. The maximum memory threshold may be preset based on an external input, but is not limited thereto. Due to the increased memory threshold, the electronic device 100 may return memory by advancing the execution of the memory return operation through process termination described above in FIG. 2 and prevent and/or reduce deterioration of performance of the device that may occur as the memory return operation through memory reallocation is performed. When the memory threshold is increased by a predetermined increment, the electronic device 100 may control not to perform the memory return operation through process termination too frequently by increasing it within the maximum memory threshold limit.

In operation S340, the electronic device 100 may determine whether the performance of the electronic device 100 is the predetermined performance criterion or more (e.g., whether the predetermined performance criterion is met), based on whether the available memory amount exceeds the maximum memory threshold and the performance information. When the available memory amount exceeds the maximum memory threshold, and the performance of the electronic device 100 is the predetermined performance criterion or more, the electronic device 100 may move to operation S350.

The predetermined performance criterion may be identified as at least one combination of the performance information. For example, in determining whether it is the predetermined performance criterion or more, the predetermined performance criterion may include at least one of the CPU usage overhead of the memory reallocation process being less than a first increase ratio (e.g., 10%) relative to the previous determination period, the swap-out/in overhead due to memory reallocation being less than a second increase ratio (e.g., 20%) relative to the previous determination period, the file drop/loading overhead due to memory reallocation being less than a third increase ratio (e.g., 20%) relative to the previous determination period, and the application response speed being less than a predetermined time (e.g., 2 seconds).

In operation S350, the electronic device 100 may decrease the memory threshold by a predetermined decrement. In this case, the electronic device 100 may decrease the memory threshold by the predetermined decrement within a limit of the minimum memory threshold. The minimum memory threshold may be preset based on an external input, but is not limited thereto. When the available memory amount exceeds the maximum memory threshold, and the performance of the electronic device 100 is the predetermined performance criterion or more, the electronic device 100 may delay the execution of the memory return operation through process termination described above in FIG. 2 due to the decreased memory threshold. When the memory threshold is decreased by a predetermined decrement, the electronic device 100 may control to perform the memory return operation through process termination, at least at a predetermined level, by decreasing it within the minimum memory threshold limit.

In operation S360, the electronic device 100 may update the memory threshold with the memory threshold determined in operation S330 or operation S350. The electronic device 100 may perform operations S210 to S230 described above in FIG. 2 using the updated memory threshold.

According to an embodiment, the predetermined increment and the predetermined decrement may be the same value (e.g., 5 Mbytes) preset based on an external input but, without limitations thereto, it will be appreciated by one of ordinary skill in the art that each may be set to various values.

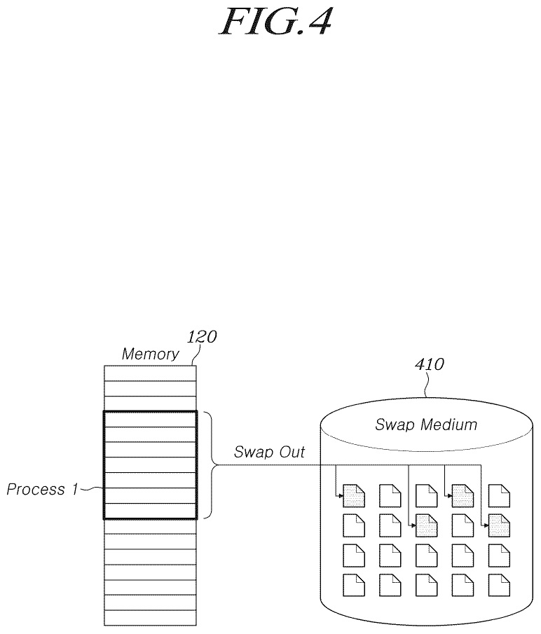

FIG. 4 is a diagram illustrating an example memory swap-out/in overhead due to memory reallocation among device performance information according to various embodiments.

Referring to FIG. 4, the processor 110 may select a process (e.g., process 1) from which to return the memory in use based on a predetermined criterion and move the memory pages in use to a swap medium 410 to thereby return the memory in use (swap-out). In this case, the processor 110 may compress the memory pages in use and then perform swap-out. The processor 110 may load the memory pages moved to the swap medium 410 back to the memory in the future (swap-in). In this case, the processor 110 may decompress the memory pages and then load them back to the memory. The processor 110 may measure at least one piece of information among the time to perform swap-out and swap-in and the number of times of swap-out/in and store the same as the performance information.

The electronic device according to various embodiments of the disclosure may be one of various types of electronic devices. The electronic devices may include, for example, a display device, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, or any combination thereof, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the electronic device 100 described herein may be implemented as a hardware component, a software component, and/or a combination thereof. The program may be executed by any system capable of executing computer-readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
a memory storing at least one instruction corresponding to at least one program; and
at least one processor, comprising processing circuitry, electrically connected to the memory, wherein at least one processor, individually and/or collectively, is configured to execute the at least one instruction as a process, and to:
obtain performance information about the electronic device and an available memory amount;
determine a memory threshold based on the performance information and the available memory amount;
update the memory threshold with the determined memory threshold; and
based on the available memory amount at a specified time being less than the memory threshold, terminate a specified process.

2. The electronic device of claim 1, wherein the performance information includes at least one of a CPU usage overhead of a memory reallocation process, a memory swap-out/in overhead due to memory reallocation, a file drop/loading overhead due to memory reallocation, and an application response speed.

3. The electronic device of claim 1, wherein at least one processor, individually and/or collectively, is configured to: obtain the performance information and available memory amount, determine the memory threshold, and update the memory threshold at a specified period.

4. The electronic device of claim 1, wherein at least one processor, individually and/or collectively, is configured to set at least one of a maximum memory threshold and a minimum memory threshold based on an external input.

5. The electronic device of claim 4, wherein at least one processor, individually and/or collectively, is configured to:
determine whether the available memory amount exceeds the memory threshold and whether a performance of the electronic device is less than a specified performance criterion based on the performance information; and
based on the performance of the electronic device being less than the specified performance criterion although the available memory amount exceeds the memory threshold, increase the memory threshold by a specified increment.

6. The electronic device of claim 4, wherein at least one processor, individually and/or collectively, is configured to:
determine whether the available memory amount exceeds the maximum memory threshold and whether a performance of the electronic device is a specified performance criterion or more based on the performance information; and
based on the performance of the electronic device being the specified performance criterion or more, and the available memory amount exceeding the maximum memory threshold, decrease the memory threshold by a specified decrement.

7. The electronic device of claim 5, wherein at least one processor, individually and/or collectively, is configured to increase the memory threshold by the specified increment within a limit of the maximum memory threshold.

8. The electronic device of claim 6, wherein at least one processor, individually and/or collectively, is configured to decrease the memory threshold by the specified decrement within a limit of the minimum memory threshold.

9. A memory management method, comprising:
obtaining performance information about an electronic device and an available memory amount;
determining a memory threshold based on the performance information and the available memory amount;
updating the memory threshold with the determined memory threshold; and
based on the available memory amount at a specified time being less than the memory threshold, terminating a specified process.

10. The memory management method of claim 9, wherein obtaining the performance information and the available memory amount, determining the memory threshold, and updating the memory threshold are performed at a specified period.

11. The memory management method of claim 9, further comprising setting at least one of a maximum memory threshold and a minimum memory threshold based on an external input.

12. The memory management method of claim 11, wherein determining the memory threshold includes:
determining whether the available memory amount exceeds the memory threshold and whether a performance of the electronic device is less than a specified performance criterion based on the performance information; and
based on the performance of the electronic device being less than the specified performance criterion although the available memory amount exceeds the memory threshold, increasing the memory threshold by a specified increment.

13. The memory management method of claim 11, wherein determining the memory threshold includes:
determining whether the available memory amount exceeds the maximum memory threshold and whether a performance of the electronic device is a specified performance criterion or more based on the performance information; and
based on the performance of the electronic device being the specified performance criterion or more, and the available memory amount exceeding the maximum memory threshold, decreasing the memory threshold by a specified decrement.

14. The memory management method of claim 12, wherein increasing the memory threshold by the specified increment increases the memory threshold by the specified increment within a limit of the maximum memory threshold.

15. The memory management method of claim 13, wherein decreasing the memory threshold by the specified decrement decreases the memory threshold by the specified decrement within a limit of the minimum memory threshold.
